(19) United States
(12) Patent Application Publication
(10) Pub. No.: US 2016/0237746 A1
(43) Pub. Date: Aug. 18, 2016

(54) Remotely Controlled Gate System

(71) Applicant: Schirado Inventions, LLC, Glen Ullin, ND (US)

(72) Inventor: Richard M. Schirado, Glen Ullin, ND (US)

(73) Assignee: Schirado Inventions, LLC

(21) Appl. No.: 15/042,848

(22) Filed: Feb. 12, 2016

Related U.S. Application Data
(60) Provisional application No. 62/115,253, filed on Feb. 12, 2015.

(51) Int. Cl. E06B 11/02

(52) U.S. Cl. CPC E06B 11/022; E06B 11/021

(57) ABSTRACT

A remotely controlled gate system which includes a controller in remote communication with an actuator for raising and lowering a gate. The remotely controlled gate system includes a pivotable first gate arm and a stationary second gate arm which are interconnected by a plurality of horizontally-extending cables across a point of egress. The first gate arm may be pivotally connected to a frame positioned at a first side of the point of egress while the second gate arm may be fixed in a vertical orientation on the second side. An actuator is connected between the frame, the first gate arm, and a locking member which releasably locks the first gate arm in a vertical position. Activation of the actuator by a remote controller is operable to both pivotally adjust the first gate arm between vertical and horizontal positions, and lock or release the first gate arm with the locking member.

### CROSS REFERENCE TO RELATED APPLICATIONS

I hereby claim benefit under Title 35, United States Code, Section 119(e) of U.S. provisional patent application Ser. No. 62/115,253 filed Feb. 12, 2015. The 62/115,253 application is currently pending. The 62/115,253 application is hereby incorporated by reference into this application.

### STATEMENT REGARDING FEDERALLY SPONSORED RESEARCH OR DEVELOPMENT

Not applicable to this application.

### BACKGROUND

1. Field

Example embodiments in general relate to a remotely controlled gate system which includes a controller in remote communication with an actuator for raising and lowering a gate.

2. Related Art

Any discussion of the related art throughout the specification should in no way be considered as an admission that such related art is widely known or forms part of common general knowledge in the field.

Gates have been in use for many years for various purposes, including in connection with home driveways, agricultural uses, and industry uses. One common gate configuration is comprised of a swinging gate door which rotates about a vertical post and swings open and shut. Another common gate configuration utilizes a single bar which is raised and lowered to provide or restrict access to an area.

While these gates may be suitable for their purposes, they do suffer from a number of shortcomings. When opened, these gates cannot be driven over, and often include structures which can damage a car if the car comes into contact with the gate or if the gate comes into contact with the car while opening or closing. These types of gates may be preferable for preventing access to cars, but often will present issues with livestock which can be injured by swinging or rotating parts.

### SUMMARY

An example embodiment of the present invention is directed to a remotely controlled gate system. The remotely controlled gate system includes a pivotable first gate arm and a stationary second gate which are interconnected by a plurality of horizontally-extending cables across a point of egress, such as a driveway or path. The first gate arm may be pivotally connected to a frame which is positioned at a first side of the point of egress while the second gate arm may be fixed in a vertical orientation on the second side of the point of egress. An actuator is connected between the frame, the first gate arm, and a locking member which releasably locks the first gate arm in a vertical position. Activation of the actuator, such as via a signal from a remote controller, is operable to both pivotally adjust the first gate arm between vertical and horizontal positions, and to lock or release the first gate arm with the locking member.

There has thus been outlined, rather broadly, some of the features of the remotely controlled gate system in order that the detailed description thereof may be better understood, and in order that the present contribution to the art may be better appreciated. There are additional features of the remotely controlled gate system that will be described hereinafter and that will form the subject matter of the claims appended hereto. In this respect, before explaining at least one embodiment of the remotely controlled gate system in detail, it is to be understood that the remotely controlled gate system is not limited in its application to the details of construction or to the arrangements of the components set forth in the following description or illustrated in the drawings. The remotely controlled gate system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a remotely controlled gate system in a raised position in accordance with an example embodiment.

FIG. 2 is a perspective view of a remotely controlled gate system in a lowered position in accordance with an example embodiment.

FIG. 3 is a perspective view of a remotely controlled gate system in a lowered position with the second gate arm disconnected in accordance with an example embodiment.

FIG. 4 is a first perspective view of a frame of a remotely controlled gate system in accordance with an example embodiment.

FIG. 5 is a second perspective view of a frame of a remotely controlled gate system in accordance with an example embodiment.

FIG. 6 is an exploded perspective view of a frame of a remotely controlled gate system in accordance with an example embodiment.

FIG. 7 is a first side view of a remotely controlled gate system in accordance with an example embodiment.

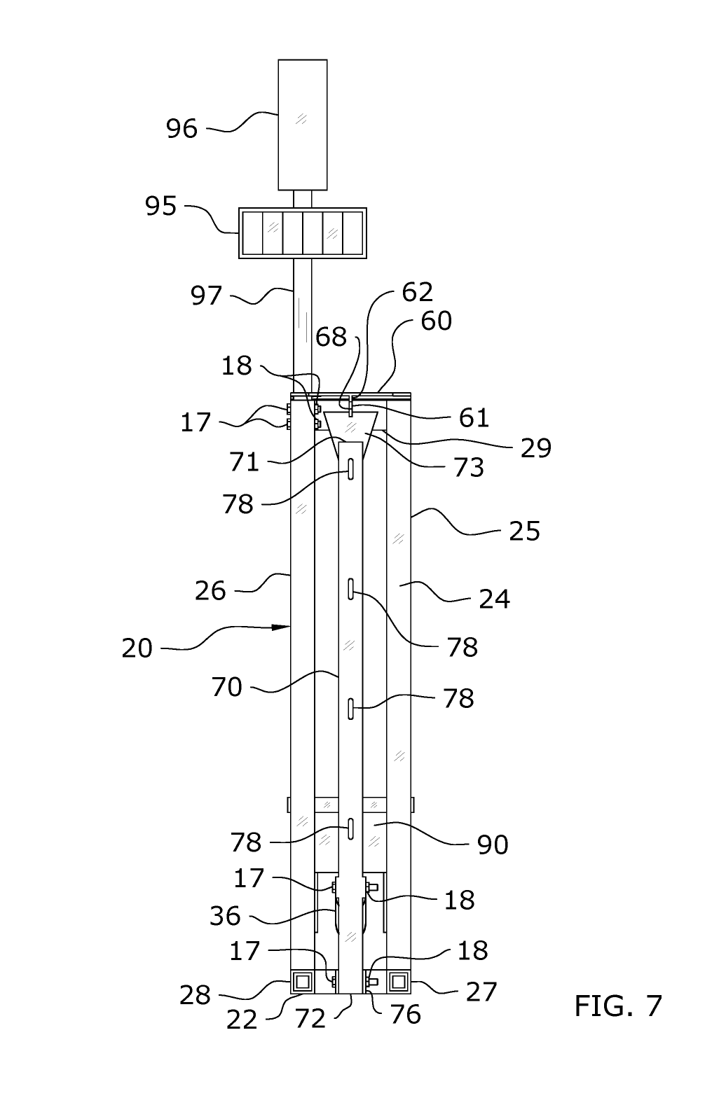

FIG. 8 is a second side view of a remotely controlled gate system in accordance with an example embodiment.

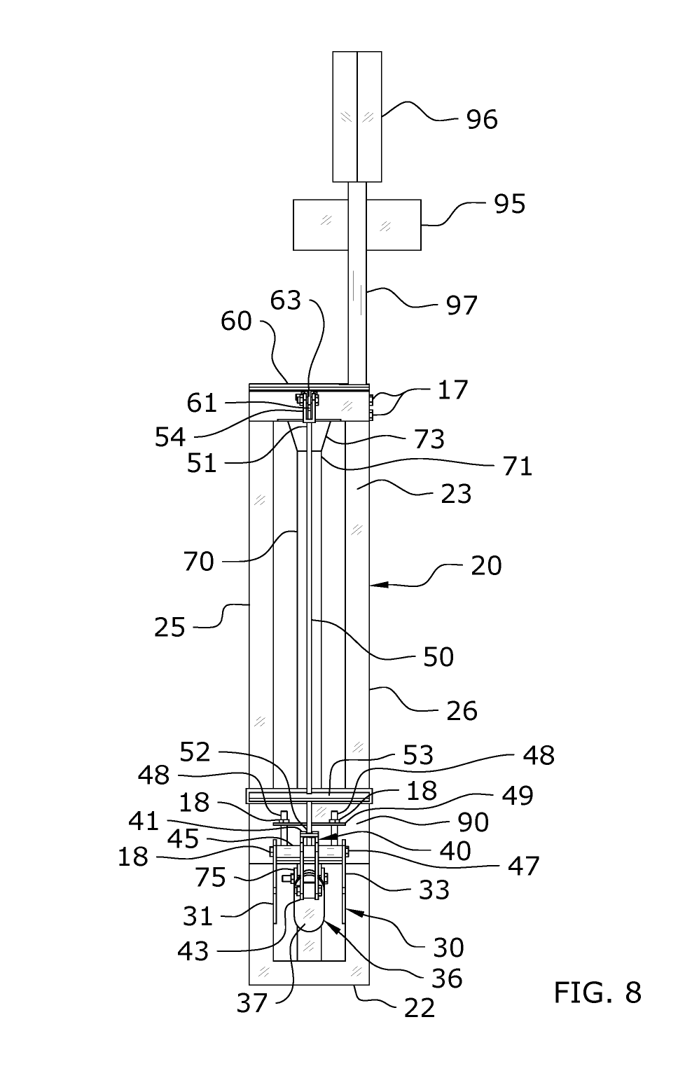

FIG. 9 is a top view of a remotely controlled gate system in accordance with an example embodiment.

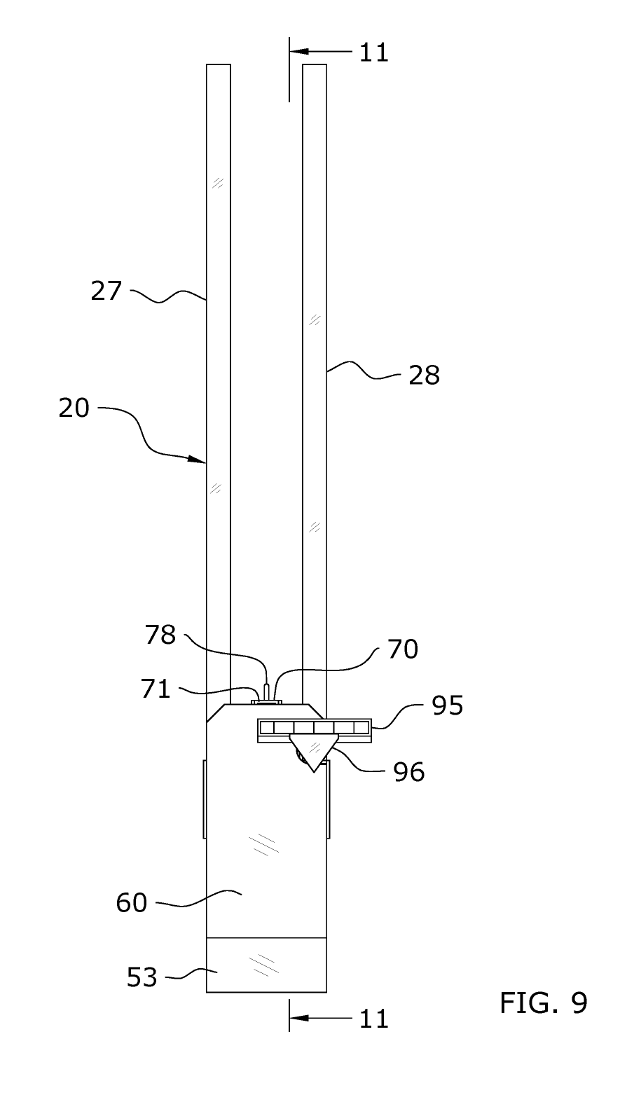

FIG. 10 is a bottom view of a remotely controlled gate system in accordance with an example embodiment.

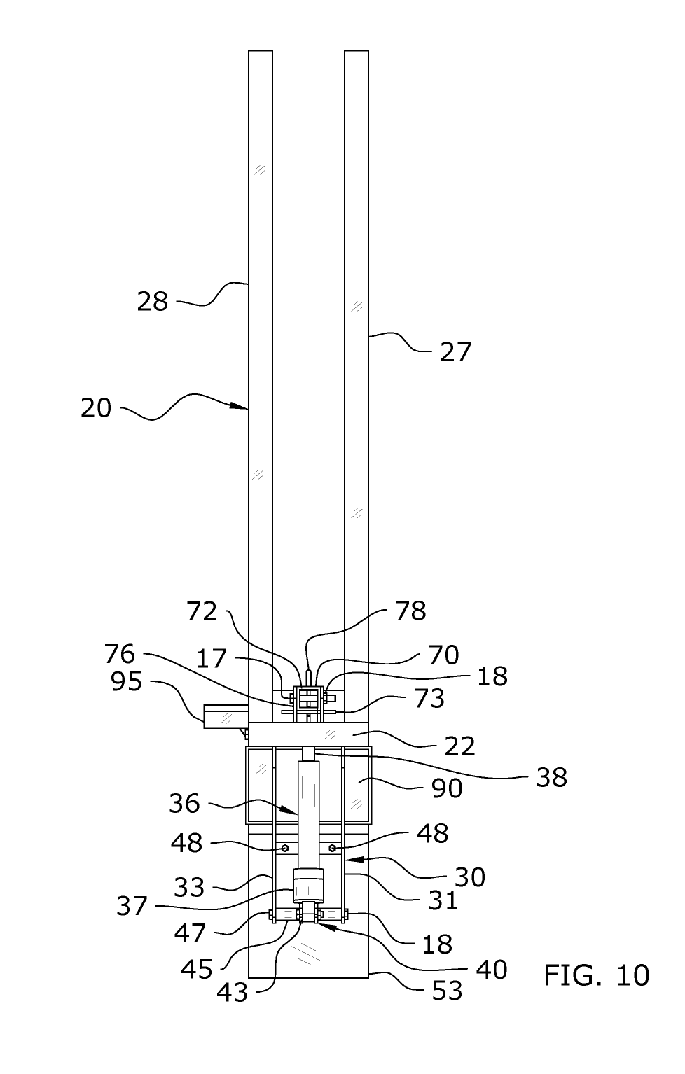

FIG. 11 is a side view of a remotely controlled gate system with the first gate arm in a vertical position.

FIG. 12 is a side view of a remotely controlled gate system illustrating release of the first gate arm being lowered into the horizontal position.

FIG. 13 is a side view of a remotely controlled gate system with the first gate arm in a horizontal position.

FIG. 14 is a side view of a remotely controlled gate system with the first gate arm being raised into the vertical position.

FIG. 15 is a side view of a remotely controlled gate system with the first gate arm locking into the vertical position.

FIG. 16 is a perspective view of an exemplary second gate arm.

FIG. 17 is a perspective view of an exemplary second gate arm being released from a gate arm receiver.

FIG. 18 is a frontal view of an exemplary second gate arm secured within a gate arm receiver.

FIG. 19 is a rear view of an exemplary second gate arm secured within a gate arm receiver.

FIG. 20 is a block diagram of an exemplary control unit.

### DETAILED DESCRIPTION

### A. Overview.

An example remotely controlled gate system generally comprises a pivotable first gate arm 70 and a stationary second gate 86 which are interconnected by a plurality of horizontally-extending cables 79 across a point of egress, such as a driveway or path. The first gate arm 70 may be pivotally connected to a frame 20 which is positioned at a first side of the point of egress while the second gate arm 86 may be fixed in a vertical orientation on the second side of the point of egress. An actuator 36 is connected between the frame 20, the first gate arm 70, and a locking member 60 which releasably locks the first gate arm 70 in a vertical position. Activation of the actuator 36, such as via a signal from a remote controller 99, is operable to both pivotally adjust the first gate arm 70 between vertical and horizontal positions, and to lock or release the first gate arm 70 with the locking member 60.

### B. Frame.

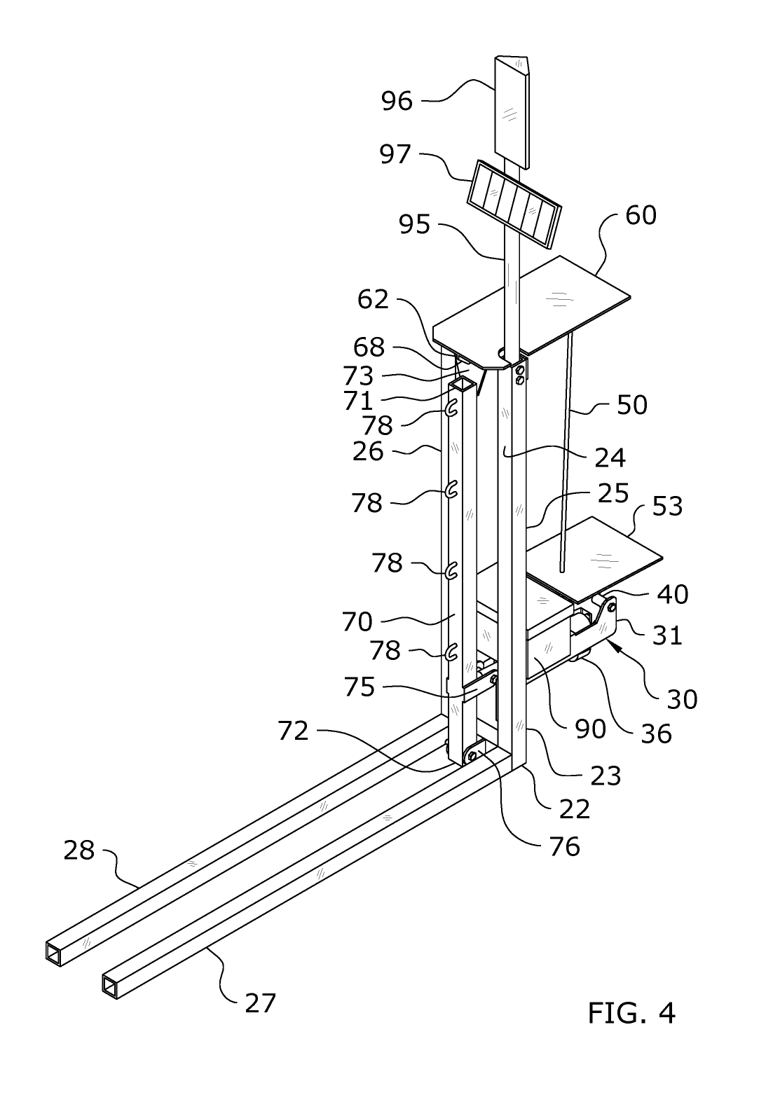

As best shown in FIGS. 4-6, an exemplary embodiment of the present invention may comprise a frame 20 which may either be free-standing or connected to another structure, such as a first gate post 12. The frame 20 will preferably be capable to supporting itself in an upright position at all times during usage, but may be reinforced by connecting to a first gate post 12 if such a structure is available.

The shape, configuration, size, and orientation of the frame 20 may vary in different embodiments. In the exemplary embodiment shown in the figures, the frame 20 comprises an upper end 21, a lower end 22, an outer end 23 which faces away from the second gate post 14, and an inner end 24 which faces toward the second gate post 14. The actuator 36, which is connected to the frame 20, will generally be adapted to pivotally actuate the first gate arm 70 inwardly from the inner end 22 of the frame 20.

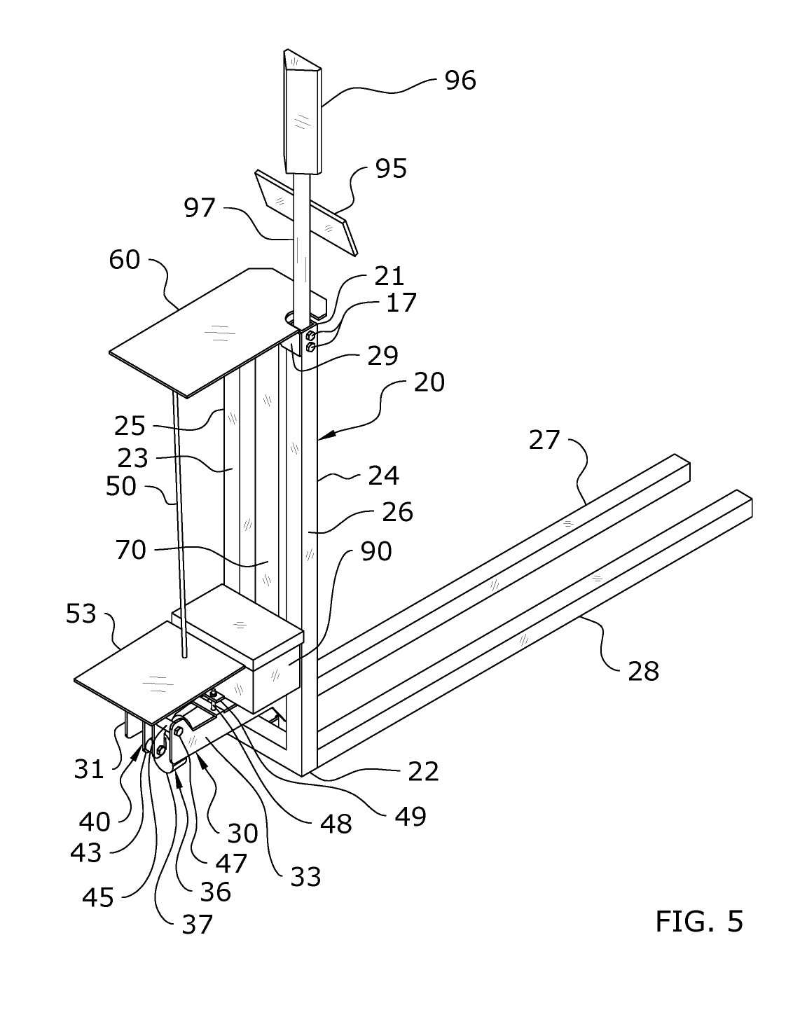

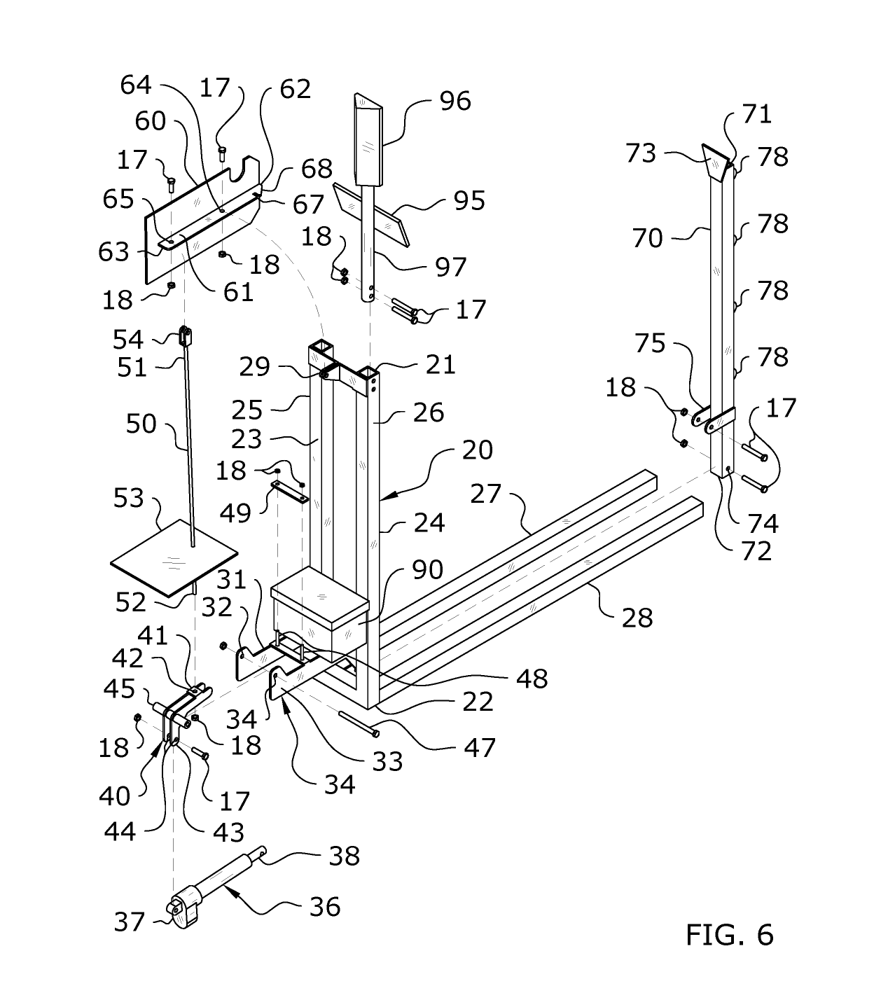

The frame 20 may, in some embodiments such as the exemplary embodiment shown in the figures, comprise a first vertical support 25 and a second vertical support 26 which extend in parallel with respect to each other. The first and second vertical supports 25, 26 extend between the upper and lower ends 21, 22 of the frame 20 such as shown in FIG. 5. The vertical supports 25, 26 provide a mounting point for the locking member 60, such as through use of an upper receiver 29 which extends between the first vertical support 25 and the second vertical support 26 at the upper end 21 of the frame 20 as shown in FIG. 6.

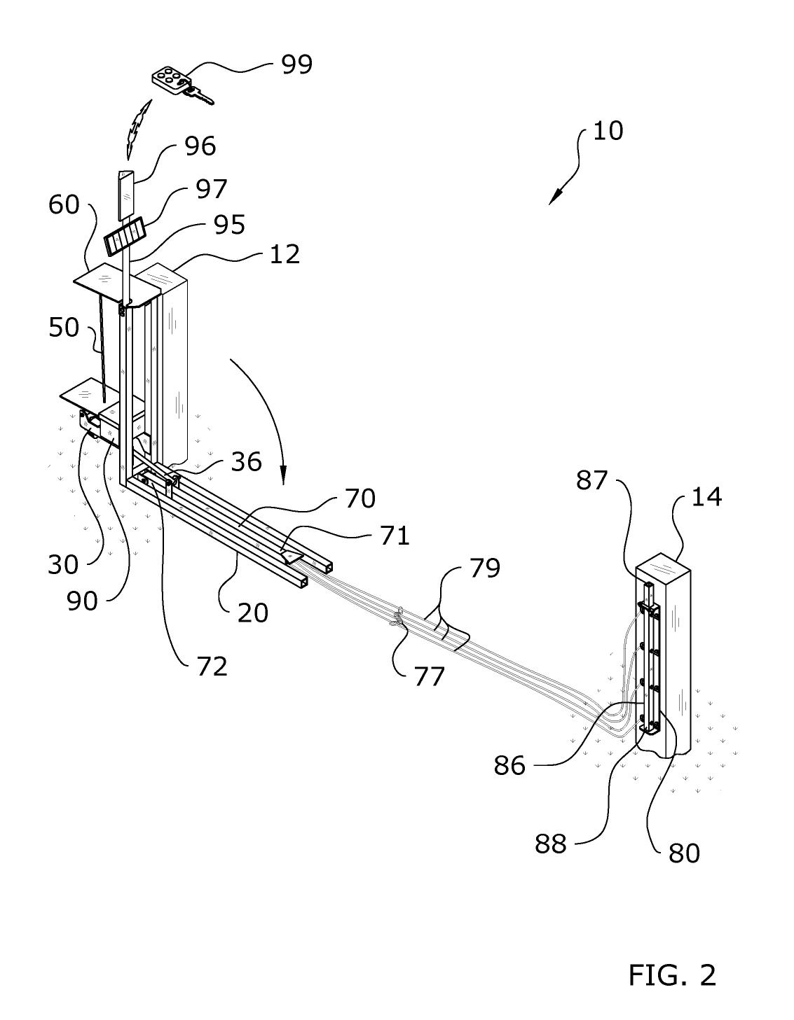

The frame 20 may also comprise a first horizontal support 27 and a second horizontal support 28 which extend horizontally from the lower end 22 of the frame 20 as best shown in FIG. 4. In some embodiments, the first horizontal support 27 may extend at a right angle from the first vertical support 25 at the lower end 22 of the frame 20 and the second horizontal support 28 may extend at a right angle from the second vertical support 26 at the lower end 22 of the frame 20. This configuration allows the frame 20 to be free-standing. The first gate arm 70 will generally be positioned between the first and second horizontal supports 27, 28 when in its lowered position, such as shown in FIG. 2.

The frame 20 may also include a pivot mount 30 to which a pivot connector 40 is pivotally connected as best shown in FIGS. 5 and 6. The pivot connector 40 is connected between the frame 20 and the actuator 36 and serves the primary function of transferring motion of the actuator 36 to the locking member 60 via the linkage 50 as described herein.

As best shown in FIG. 6, the pivot mount 30 will generally be connected to the outer end 23 of the frame 20 at a position near the lower end 22 of the frame 20. The pivot mount 30 may comprise various configurations, including the bracket configuration shown in the figures which comprises a first mount 31 having a first opening 32 at its distal end and a second mount 33 having a second opening 34 at its distal end. The first and second mounts 31, 33 extend in parallel from the outer end 23 of the frame 20 such that the pivot connector 40 may be connected between the first and second mounts 31, 33 as shown in FIG. 5.

The pivot connector 40 is adapted to pivot in a first direction with respect to the frame 20 when the actuator 36 extends and to pivot in a second direction with respect to the frame 20 when the actuator 36 retracts. More specifically, in embodiments in which the pivot connector 40 is pivotally connected within the pivot mount 30, the pivot connector 40 will pivot within and with respect to the pivot mount 30. The pivoting motion of the pivot connector 40 will force the linkage 50 upward or downward, resulting in raising or lowering of the locking member 60 between its lock position and its release position as described herein.

The pivot connector 40 may comprise various configurations and should not be construed as limited by the exemplary configuration shown in the figures. In a preferred embodiment as shown in FIG. 6, the pivot connector 40 comprises a shoulder connector configuration having an upper end 41 and a lower end 43. The pivot connector 40 may comprise an L-shaped configuration as shown or may comprise different shapes.

The upper end 41 of the pivot connector 40 will generally include an upper receiver 42 to which the lower end 52 of the linkage 50 may be connected. The lower end 43 of the pivot connector 40 may include one or more lower openings 44 which are utilized to pivotally connect the lower end 43 of the pivot connector 40 with the actuator 36, such as via a fastener 17 and nut 18 as shown in FIG. 6.

A pivot receiver 45 extending through a central portion of the pivot connector 40 is adapted to receive a pivot pin 47 which pivotally connected the pivot connector 40 within the pivot mount 30 as shown in FIGS. 5 and 6. In some embodiments, a discrete pivot receiver 45, comprised of a tube as shown in the figures, may be omitted. The pivot receiver 45 is preferable, however, to prevent side-to-side movement of the pivot connector 40 within the pivot mount 30.

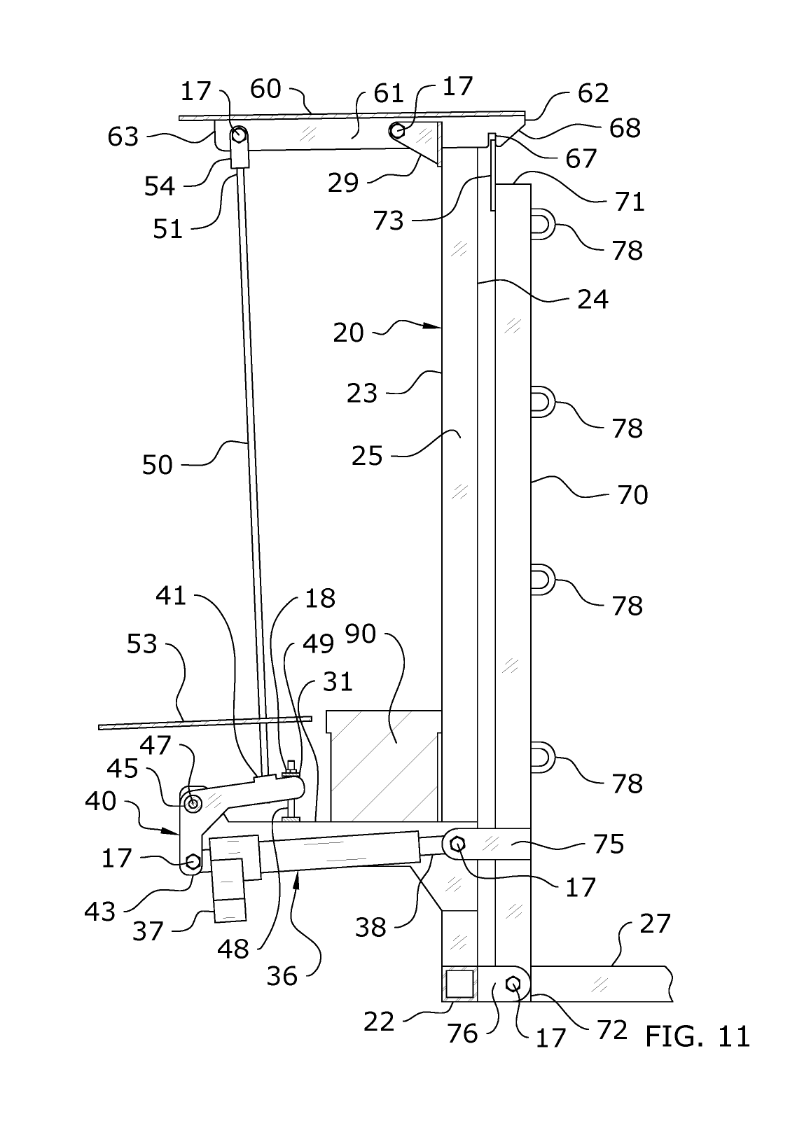

The pivot connector 40 may be prevented from pivoting too far in a direction by an anchor 49 as best shown in FIG. 11. The anchor 49 may comprise a plate or other type of member which extends between the upper ends of two bolts 48. The bolts 48 are positioned on either side of the pivot connector 40 so that, when the pivot connector 40 is pivoted too far in an upward position, its upper end 41 is stopped by the anchor 49. As shown in the figures, the bolts 48 may be connected to the pivot mount 30, with the first bolt 48 extending from the first mount 31 and the second bolt 48 extending from the second mount 32. The anchor cross between the two bolts 48 to block upward motion of the pivot connector 40 past a certain distance.

### C. Actuator.

As shown throughout the figures, an actuator 36 is utilized to pivotally adjust the first gate arm 70 between a horizontal position and a vertical position. The actuator 36 also provides the added functionality of adjusting the locking member 60 between its lowered, lock position and it's raised, release position. Various types of actuators 36 may be utilized, including electrical, hydraulic, gasoline-powered, and the like.

Preferably, a linear actuator 36 as shown in the figures will be utilized which comprises a base 37 and a shaft 38 movably extending into and out of the base 37. In the embodiment shown in the figures, the actuator 36 is connected between the frame 20 and the first gate arm 70. Although the figures illustrate that the base 37 of the actuator 36 is connected to the frame 20 and the shaft 38 of the actuator 36 is connected to the first gate arm 70, it should be appreciated that the reverse configuration could be utilized in some embodiments.

In the preferred embodiment shown in FIGS. 4-6, the actuator 36 is connected between the pivot connector 40 and the first gate arm 70 such that the actuator 36 provides pivoting motion to both the pivot connector 40 and the first gate arm 70 simultaneously. In the embodiment shown in the figures, the base 37 of the actuator 36 is connected to the pivot connector 40, allowing the actuator 36 to pivot the pivot connector 40 with respect to the frame 20 or pivot mount 30.

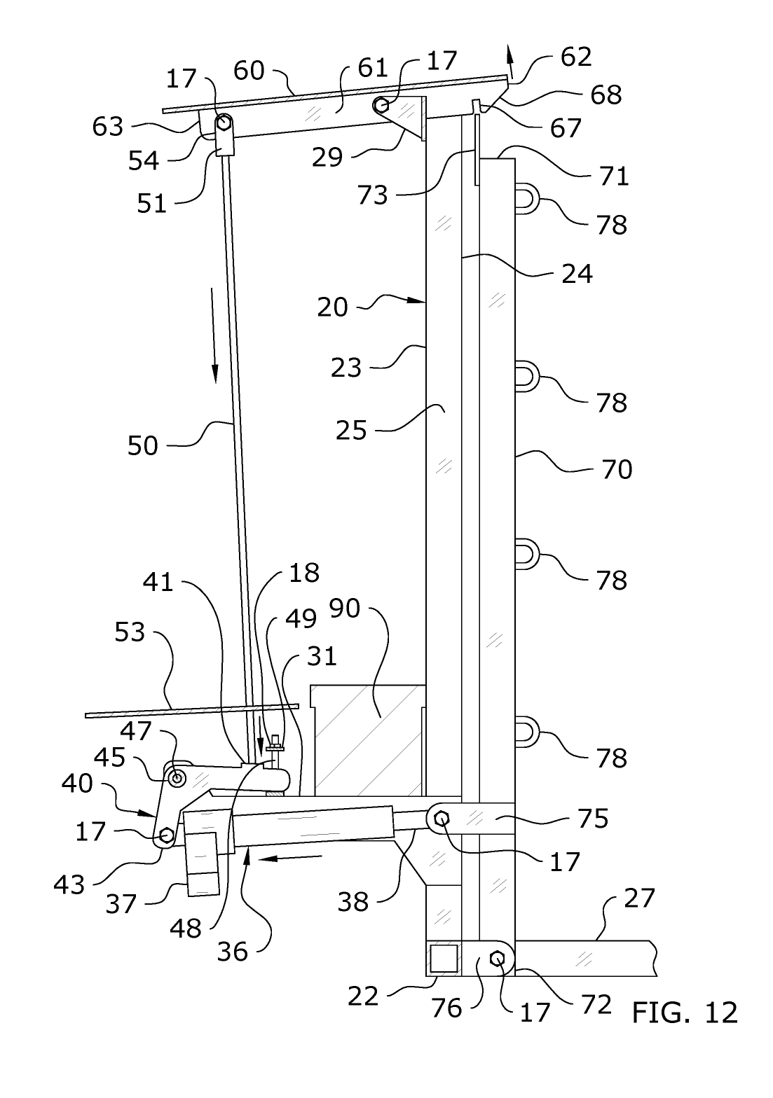

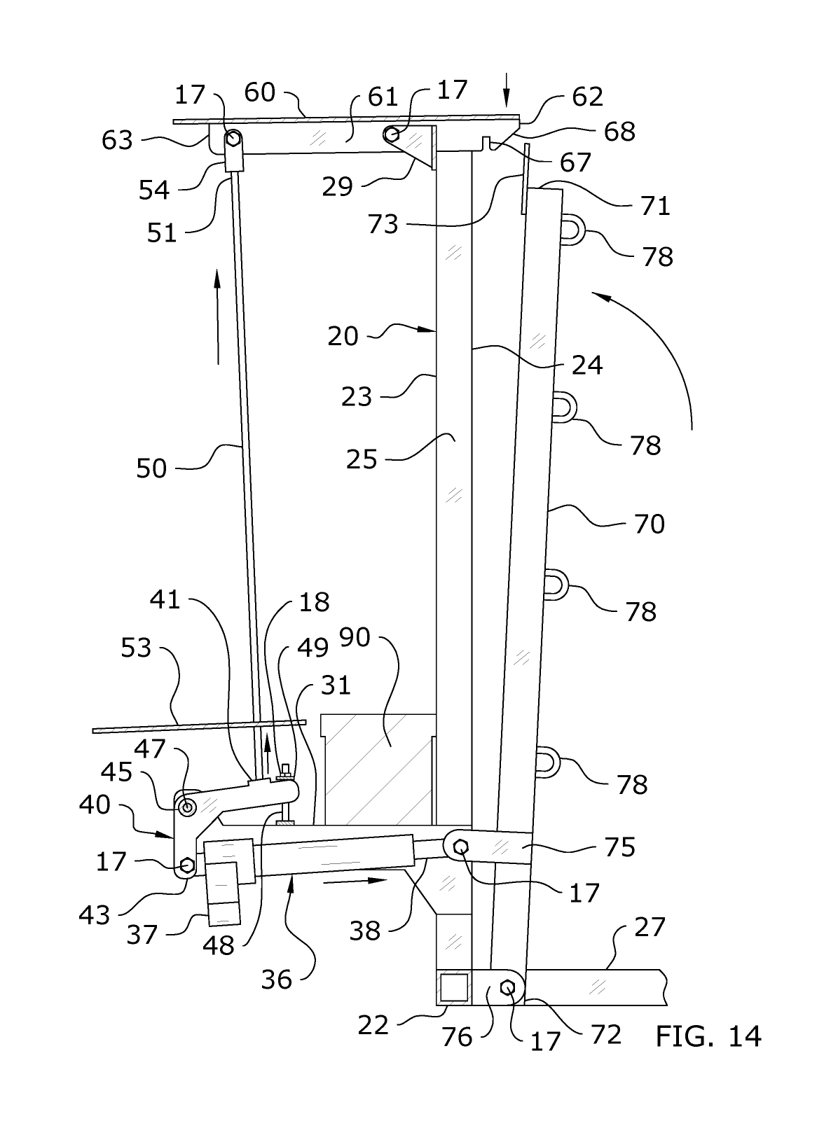

As best shown in FIG. 6, the base 37 of the actuator 36 is pivotally connected to the lower end 43 of the pivot connector 40. Using this configuration in combination with the pivotal connection of the pivot connector 40 within the pivot mount 30 allows for the upper end 41 of the pivot connector 40 to lower when the actuator 36 is extended as shown in FIG. 12 and to raise when the actuator 36 is retracted as shown in FIG. 14.

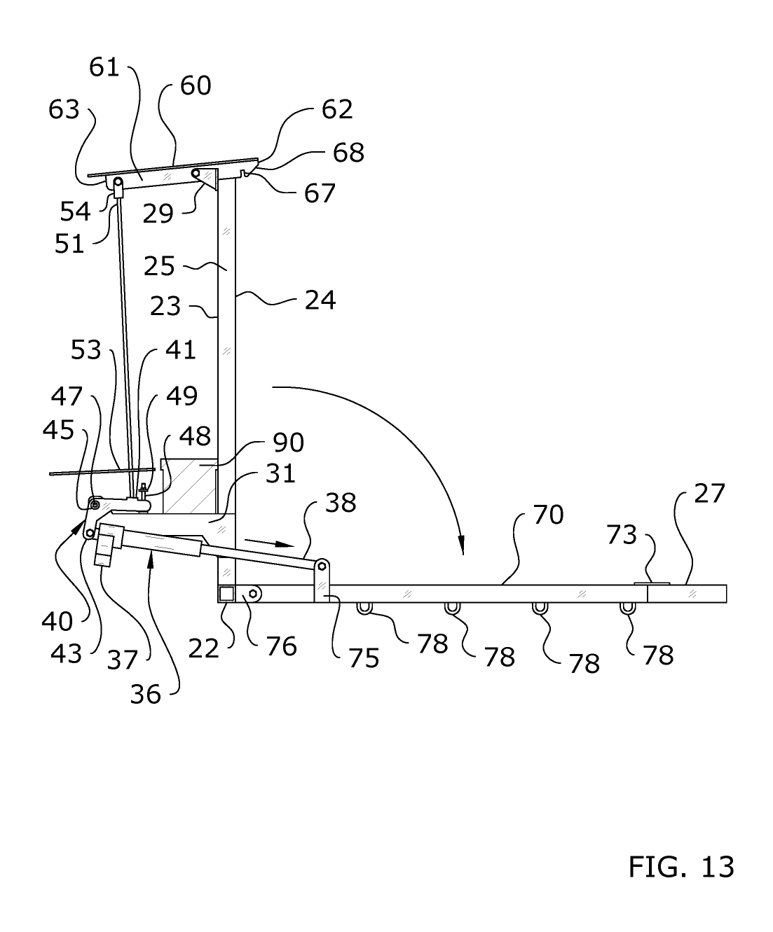

As shown throughout the figures, the shaft 38 of the actuator 36 is connected to the first gate arm 70, such as via the first gate bracket 75 as best shown in FIG. 13. The actuator 36 is adapted to adjust the first gate arm 70 between a horizontal position and a vertical position. As shown throughout the figures, extension of the actuator 36 is operable to pivotally lower the first gate arm 70 into a horizontal position and retraction of the actuator 36 is operable to pivotally raise the first gate arm 70 into a vertical position. The reverse configuration could be utilized in some embodiments, however, and the specific motion of the actuator 36 shown in the exemplary figures should not be construed as limiting.

### D. Locking Member.

As shown throughout the figures, the present invention may utilize a locking member 60 which is adapted to lock the first gate arm 70 in its vertical position and to release the first gate arm 70 prior to its adjustment into the horizontal position. The locking member 60 may be connected to an upper end 21 of the frame 20, or various other locations along the frame 20.

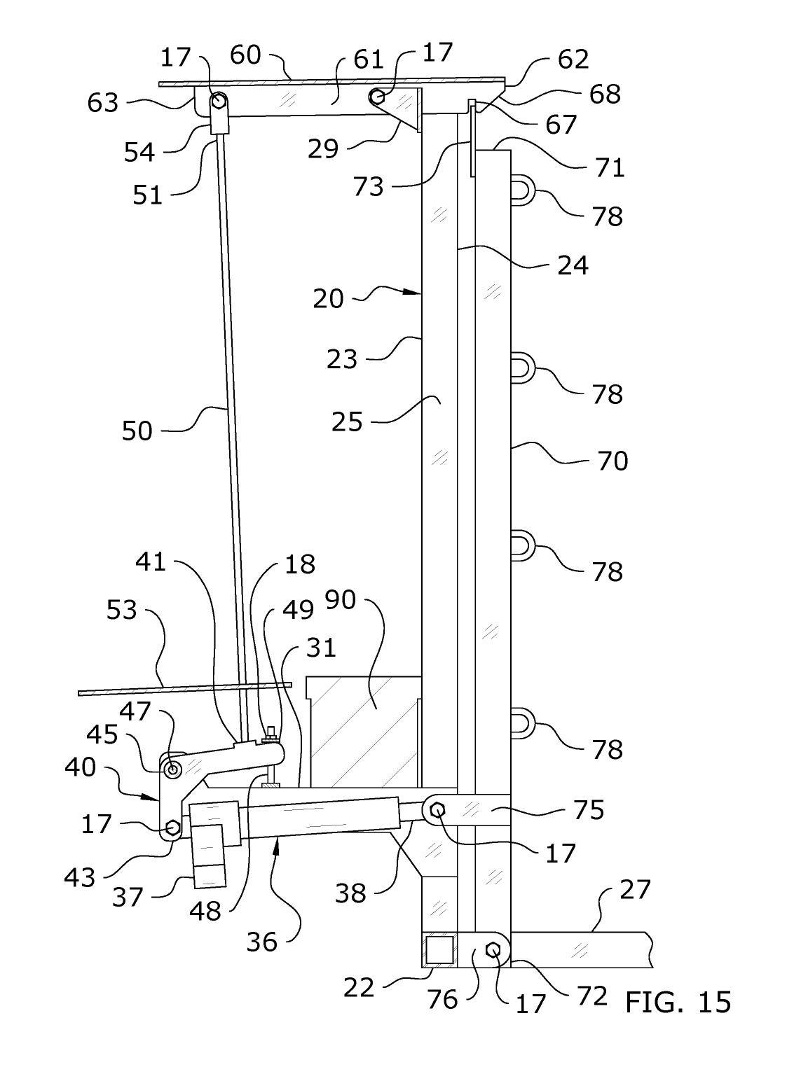

The locking member 60 is adjustable between a lock position for removably securing the first gate arm 70 in a vertical position and a release position for releasing the first gate arm 70 to be adjusted into its horizontal position. Extension of the actuator 36 is operable to lift the locking member 60 into the release position and retraction of the actuator 36 is operable to lower the locking member into the lock position, or vice versa depending on the embodiment. The locking member 60 is shown in its lock position, in which the first gate arm 70 is locked with the locking member 60, in FIGS. 11 and 15. The locking member 60 is shown in its release position, in which the first gate arm 70 is released and free to pivot, in FIGS. 12-14.

The shape, structure, and configuration of the locking member 60 may vary in different embodiments. FIGS. 4-6 illustrate an exemplary embodiment of the locking member 60 which comprises a plate-like configuration having a lower flange 61 extending downwardly from its lower end. The lower flange 61 comprises a first end 62 positioned near a first side of the locking member 60 and a second end 63 positioned near or extending from a second side of the locking member 60. The lower flange 61 is utilized to pivotally secure the locking member 60 to the frame 20, such as via the upper receiver 29 as shown in FIG. 6.

As shown in FIG. 6, the lower flange 61 will generally comprise a first flange opening 64 near the mid-point of the lower flange 61 and a second flange opening 65 near the second end of the lower flange 61. The first flange opening 64 is adapted to be receive a fastener 17 to pivotally connect the lower flange 61 to the frame 20. The second flange opening 65 is adapted to receive a fastener 17 to pivotally connect the lower flange 61 to the upper end 61 of the linkage 50. Thus, the motion of the linkage 50 will cause the locking member 60 to pivot about the first flange opening 64.

The first end 62 of the lower flange 61 includes a notch 67 which is adapted to lockably and releasably engage with the first gate arm 70. The lower flange 61 may include a sloped portion 68 at its first end 62 which leads to the notch 67 so that the first gate arm 70 follows the sloped portion 68 prior to being locked within the notch 67. The shape, size, placement, and configuration of the notch 67 may vary in different embodiments.

As best shown in FIGS. 4-6, a linkage 50 is connected between the pivot connector 40 and the locking member 60. The linkage 50 translates movement of the actuator 36 into movement of the locking member 60. The linkage 50 generally comprises an elongated rod or the like comprising an upper end 51 pivotally connected to the locking member 60 and a lower end 52 connected to the pivot connector 40, such as via its upper receiver 42.

A guide plate 53 may be provided through which the linkage 50 extends to provide additional stability as shown in FIG. 6. An upper connector 54 at the upper end 51 of the linkage 50 may effectuate the pivotal connection between the linkage 50 and the lower flange 61 of the locking member 60.

As the pivot connector 40 is pivoted within the pivot mount 30 by the actuator 36, the linkage 50 will be lifted or lowered. Lifting the linkage 50 will release the first gate arm 70 from the notch 67 of the locking member 60 and allow the first gate arm 70 to pivot downwardly into its horizontal position. Lowering the linkage 50 will place the locking member 60 in its lock position, in which the first gate arm 70 will slide into the notch 67 to be locked therein if forced back into contact with the locking member 60, such as by being pivoted upwardly.

### E. Gate Arms.

As show throughout the figures, a first gate arm 70 and a second gate arm 86 are provided with one or more cables 79 extending therebetween to form the gate structure. The first gate arm 70 is pivotally connected to the frame 20. The second gate arm 86 will generally be fixed in a stationary, vertical position, such as by being secured against a second gate post 14 as shown in the figures.

The first and second gate arms 70, 86 are connected by at least one cable 79. Preferably, a plurality of cables 79 are utilized. The cables 79 may comprise various elongated members which extend between the gate arms 70, 86 to block passage therebetween. The cable 79 extends horizontally between the first and second gate arms 70, 86 when the first gate arm 70 is in a vertical position; thus forming a gate structure to block passage. The cable 79 lays upon a ground surface where it may be easily walked or driven over when the first gate arm 70 is in a horizontal position. A cable retainer 77 may be provided to maintain the cables 79 in parallel orientation at equal spacing when the cables 79 are horizontally extended between the two upright gate arms 70, 86 and to ensure that the cables 79 lay flat when they are resting on the ground surface.

a. Actuated Gate Arm

As shown throughout the figures, the first gate arm 70 is pivotally connected to the frame 20 such that the first gate arm 70 may be adjusted between a vertical position and a horizontal position. The first gate arm 70 generally comprises an elongated member such as a rod, shaft, or the like which includes an upper end 71 and a lower end 72. The upper end 71 of the first gate arm 70 may include an upper fin 73 for releasably engaging with the notch 67 of the locking member 60.

The lower end 72 of the first gate arm 70 may include lower openings 74 as shown in FIG. 6 which are utilized to pivotally connect the lower end 72 of the first gate arm 70 with the frame 20, such as via a frame bracket 76 positioned between the first and second horizontal supports 27, 28 of the frame 20.

A first gate bracket 76 is positioned slightly above the lower end 72 of the first gate arm 70. The shaft 38 of the actuator 36 is attached to the first gate bracket 76 as shown in the figures such that extension or retraction of the actuator 36 will pivot the first gate arm 70 about its lower end 72 with respect to the frame 20. The first gate arm 70 may include a plurality of first receiver loops 78 along its length to which the cables 79 may be attached.

b. Stationary Gate Arm.

As shown throughout the figures, a second gate arm 86 is provided which is adapted to remain stationary and fixed in a vertical orientation as a fixed gate arm opposite the pivotally-adjustable first gate arm 70. The second gate arm 86 may be free-standing (i.e., secured within the ground), or may be connected against a second gate post 14 as shown in the figures. The second gate arm 86 comprises an upper end 81 and a lower end 82, with a plurality of second receiver loops 89 to which the cables 79 may be attached.

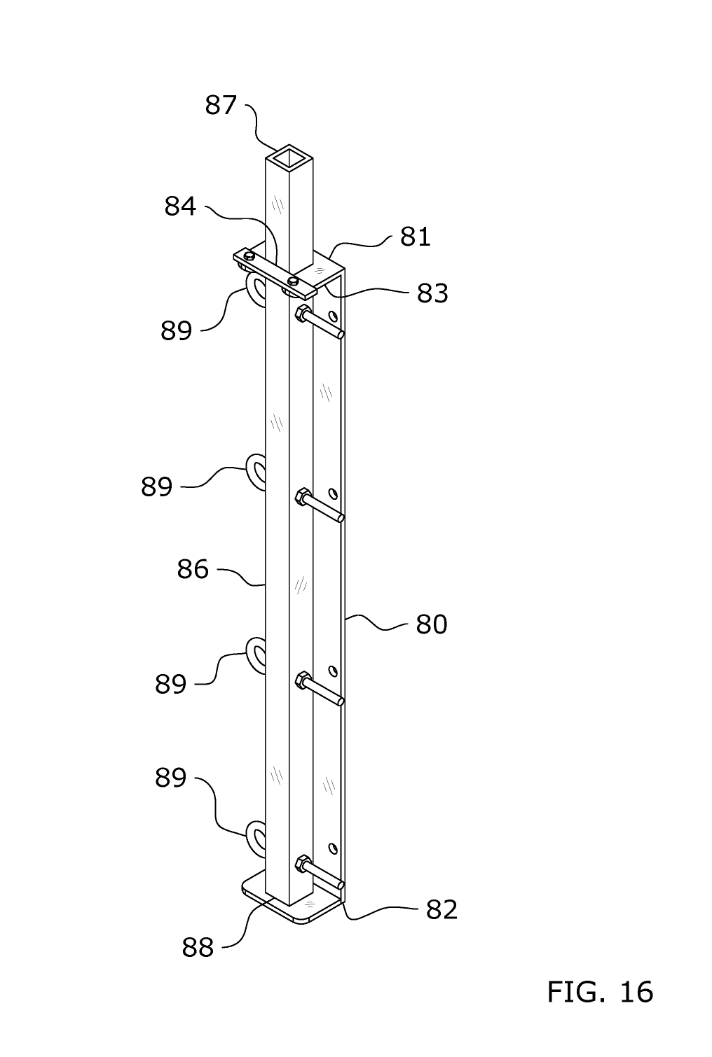

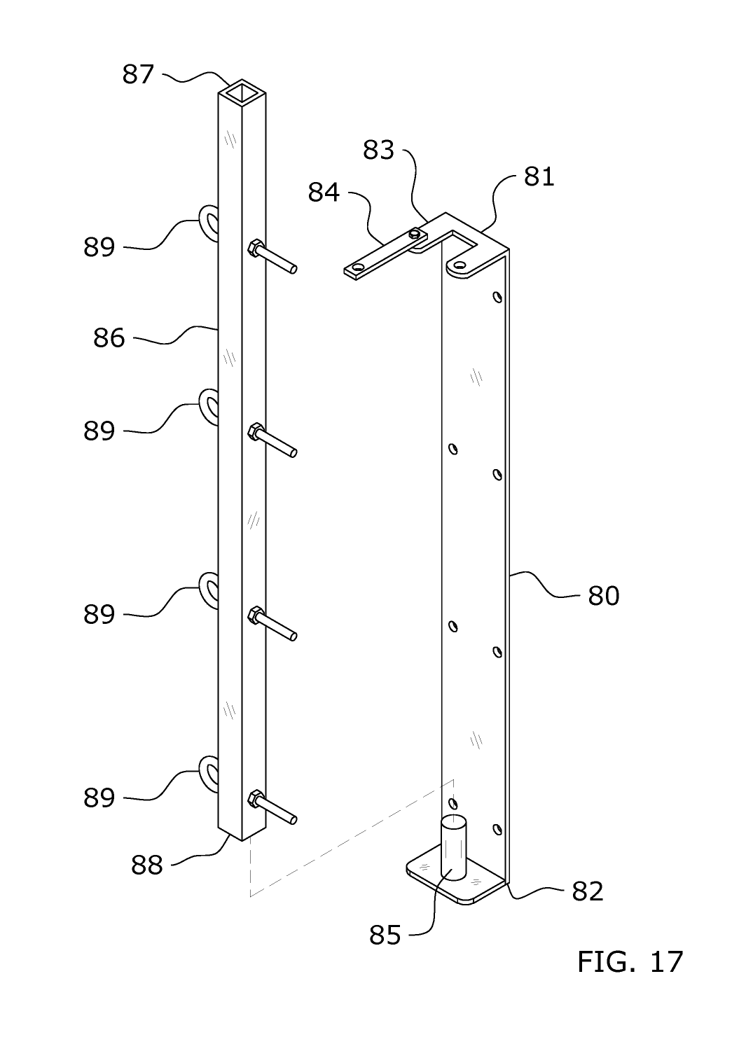

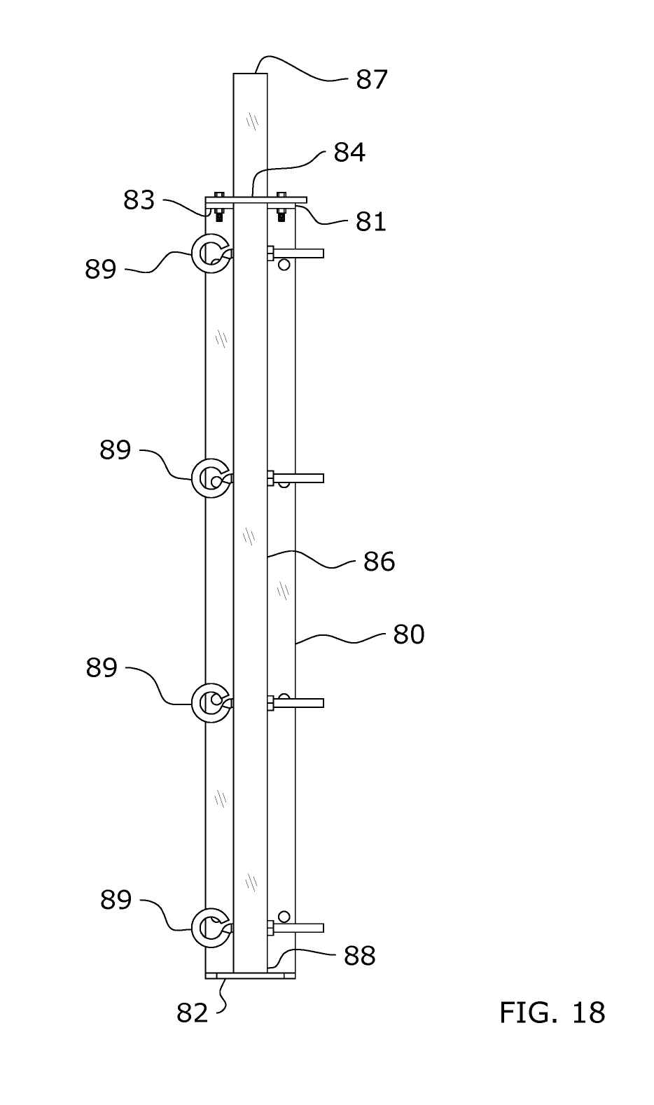

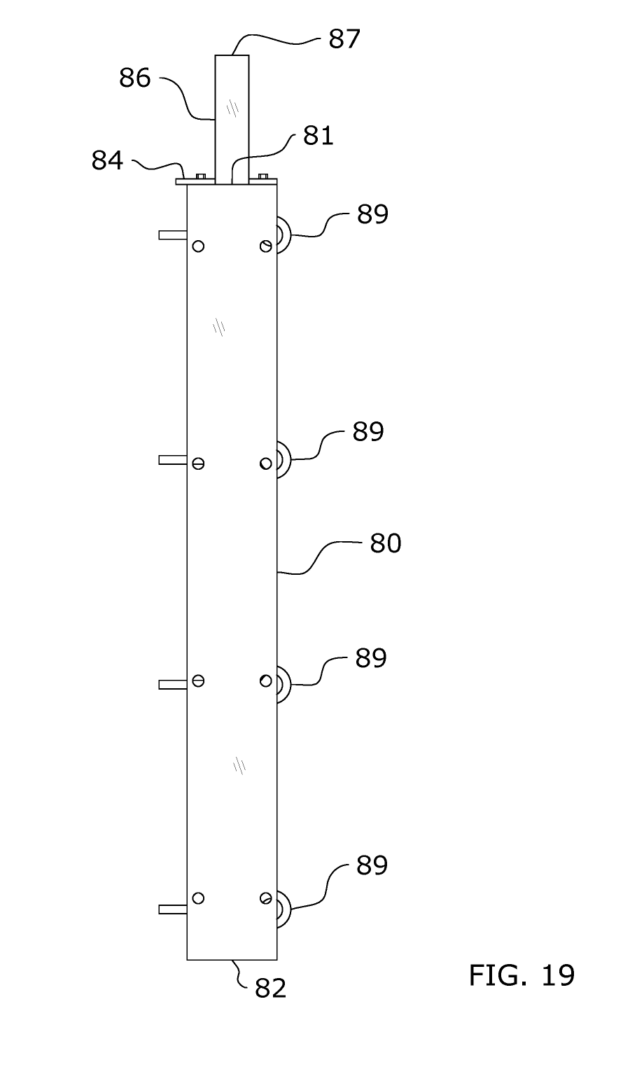

In embodiments utilizing a second gate post 14, a gate arm receiver 80 may be utilized to connect the second gate arm 86 with the second gate post 14. The gate arm receiver 80 may comprise an elongated member as shown in FIGS. 16-19 which is secured against the second gate post 14, such as via fasteners 17. The gate arm receiver 80 comprises an upper end 81 and a lower end 82, wherein the upper end 81 includes an upper receiver bracket 83 and clip 84 for locking the second gate arm 86 within the gate arm receiver 80. The lower end 82 may include a gate arm mount 85 onto which the second gate arm 86 may be secured.

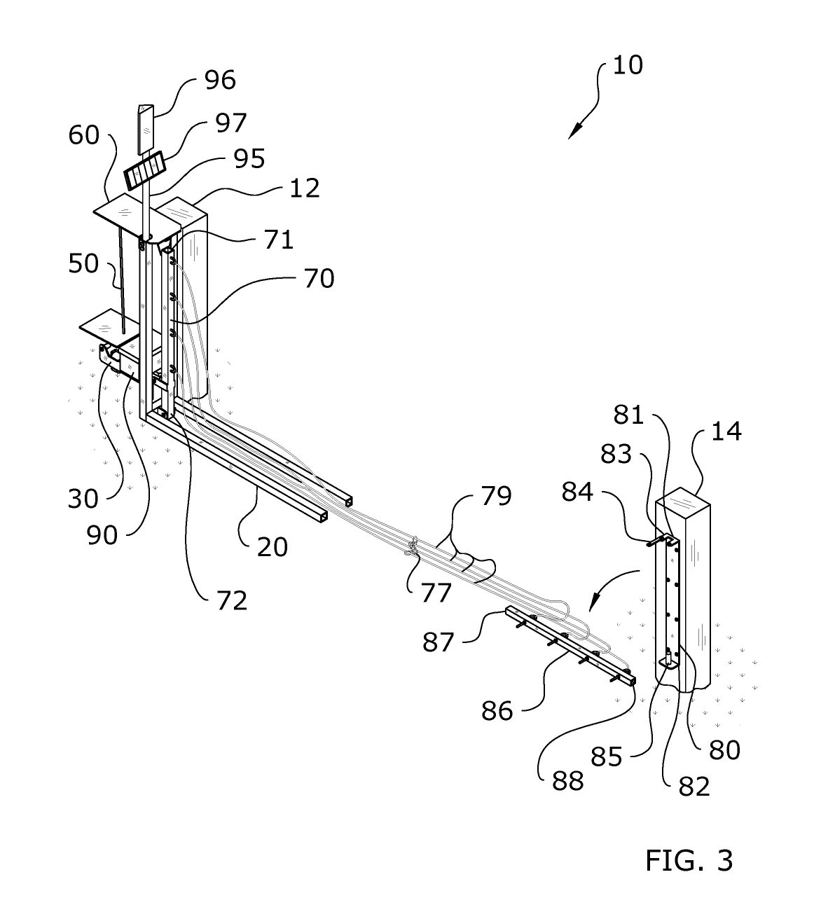

Thus, the second gate arm 86 is preferably removably secured against the second gate post 14. This configuration allows for the gate to be taken down in the event of failure of the actuator 36 or other components. FIG. 3 illustrates the embodiment in which the second gate arm 86 has been manually released to allow lowering of the cables 79 when the actuator 36 or other components have failed or locked up.

### F. Remote Control of the Actuator.

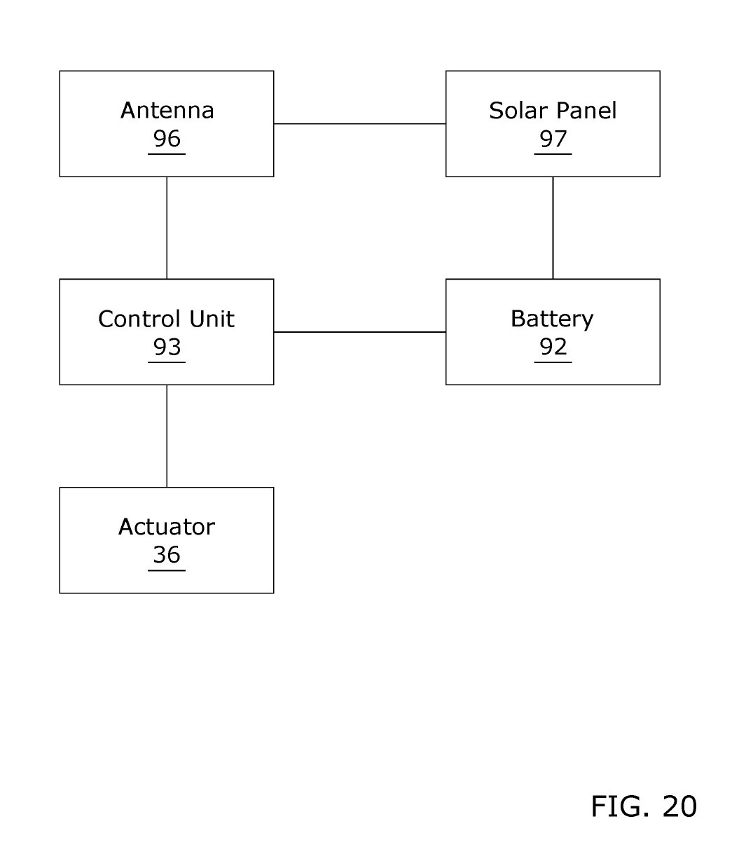

As best shown in FIGS. 6 and 20, a control unit 93 may be provided to communicative with a remote controller 99. The control unit 93 may comprise a receiver, switch, and/or other circuitry which is adapted to communicate with the remote controller 99, such as via an antenna 96 connected to the frame 20 by a support post 95 as shown in FIG. 6.

The controller 99 may comprise various remote devices adapted to send signals to the control unit 93, such as a key fob or a mobile phone. The controller 99 will generally send a signal to the control unit 93, such as via the antenna 96. The control unit 93 is preferably connected to the actuator 36 such that the control unit 93 may extend or retract the actuator 36 in response to signals from the remote controller 99.

A battery 92 may also be provided for use with the actuator 36 in embodiments which utilize an electric actuator 36. In such embodiments, a solar panel 97 may be provided to charge the battery 92. The solar panel 97 may be connected to the frame 20, such as on the support post 95 with the antenna 96 as shown in FIG. 6.

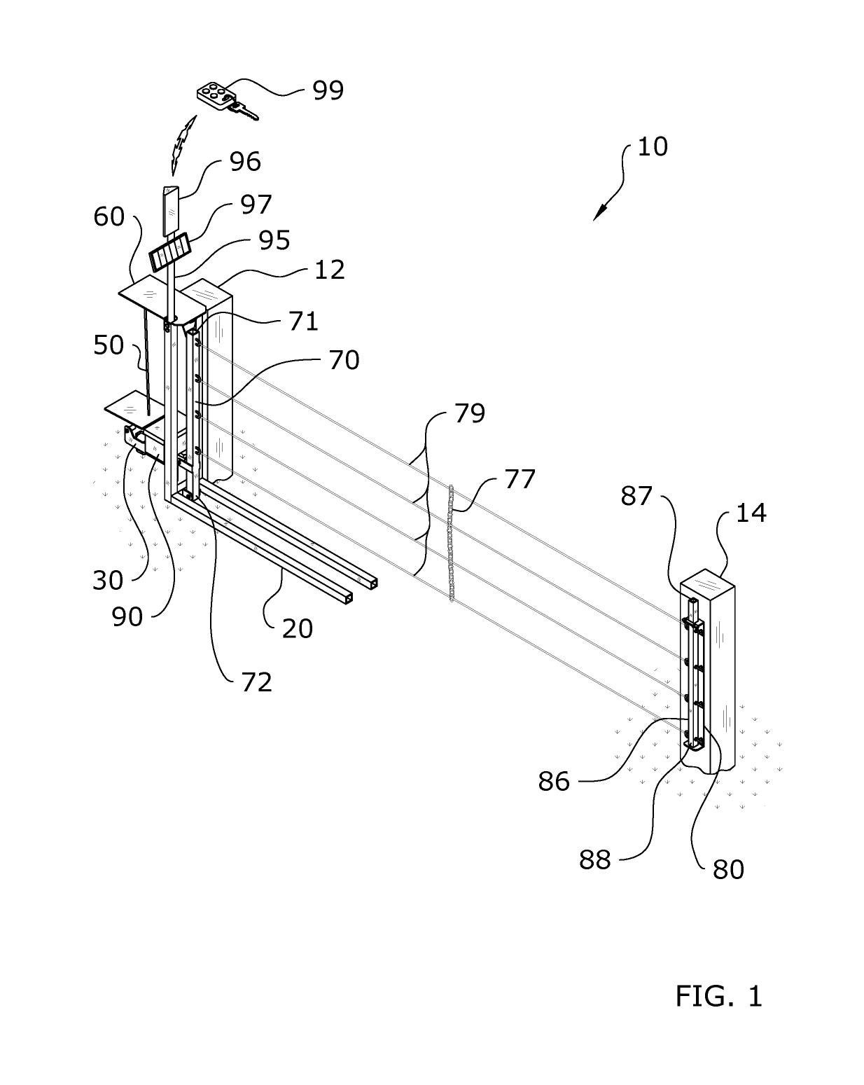

A housing 90 may be provided as shown in FIGS. 1-5 to protect the battery 92 and/or control unit 93. The housing 90 may be positioned at various locations along the frame 20. Preferably, the housing 90 will be positioned near the outer end 23 of the frame 20 so as to be out of the way of the pivoting first gate arm 70, pivot connector 40, and actuator 36. As shown in the figures, the housing 90 may in some embodiments be secured on the pivot mount 30.

### G. Operation of Preferred Embodiment.

In use, the frame 20 is first positioned on a first side of a point of egress, such as a driveway or a pathway crossing a fence. If an existing first gate post 12 is present, such as at the termination point of a fence or pre-existing from a prior gate installation, the frame 20 may be secured against or connected to the first gate post 12. If no such gate post 12 exists, the frame 20 may freely stand.

The second gate arm 86 is secured in a fixed, vertical orientation on the second side of the point of egress. If an existing second gate post 14 is present, the second gate arm 86 may be secured against or connected to the second gate post 14. For example, a gate arm receiver 80 may be connected against the second gate post 14 to which the second gate arm 86 may be removably connected. The use of such a gate arm receiver 80 allows the second gate arm 86 to be quickly and easily removed in the event of failure of other components such as the actuator 36. If no existing second gate post 14 is present, the second gate arm 86 could be secured within the ground surface with various methods known in the art for anchoring an elongated member into the ground.

With the frame 20 and second gate arm 80 properly installed, the first gate arm 70 is raised into its vertical position so that the upper end 71 of the gate arm 70 is engaged with the locking member 60. If not already installed, the cables 79 may be connected between the first and second gate arms 70, 86. The cable retainers 77 may be installed to create a uniform spacing between the parallel extending cables 79 between the first and second gate arms 70, 86.

When desired, the first gate arm 70 may be pivotally lowered into a horizontal position between the first and second horizontal supports 27, 28 of the frame 20. To do so, the controller 99 is activated to send a signal which is received by the antenna 96. The control unit 93 processes the signal and activates the actuator 36 to extend.

As shown in FIG. 12, extension of the actuator 36 pivots the pivot connector 40 to pull the linkage 50 downwardly. The downward motion of the linkage 50 pivots the locking member 50 into a release position such that the first gate arm 70 is released from the notch 67. Extension of the actuator 36 also pushes the first gate arm 70 to pivotally lower itself after being freed of the locking member 60 as shown in FIG. 13. With the first gate arm 70 lowered into a horizontal position, the cables 79 are lowered to rest along the ground surface and a vehicle or the like may freely pass thereover. In the event of actuator 36 failure, the second gate arm 86 may be removed from the second gate post 14 to lower the cables 79 from the side of the second gate arm 86 as shown in FIG. 3.

To close the gate and prevent passage, the controller 99 may be activated again to transmit another signal to the control unit 93 via the antenna 96. The control unit 93 directs the actuator 36 to retract as shown in FIG. 14. The retraction of the actuator 36 pushes the linkage 50 upwardly; causing the locking member 60 to pivot back into the lock position. At the same time, the retraction of the actuator 36 pulls the first gate arm 70 pivotally upward into its vertical position, where the locking member 60 engages with the first gate arm 70 to retain the first gate arm 80 in vertical position as shown in FIG. 15. With the first gate arm 70 so oriented, the cables 79 extend horizontally between the first and second gate arms 70, 86 to prevent passage across the point of egress.

Unless otherwise defined, all technical and scientific terms used herein have the same meaning as commonly understood by one of ordinary skill in the art to which this invention belongs. Although methods and materials similar to or equivalent to those described herein can be used in the practice or testing of the remotely controlled gate system, suitable methods and materials are described above. All publications, patent applications, patents, and other references mentioned herein are incorporated by reference in their entirety to the extent allowed by applicable law and regulations. The remotely controlled gate system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A remotely controlled gate system, comprising:
a frame;
a first gate arm pivotally connected to the frame;
an actuator connected between the frame and the first gate arm, wherein the actuator is adapted to pivotally adjust the first gate arm between a horizontal position and a vertical position; and
a second gate arm connected to the first gate arm by at least one cable.

2. The remotely controlled gate system of claim 1, wherein the second gate arm is fixed in a vertical orientation.

3. The remotely controlled gate system of claim 1, wherein the at least one cable is flexible.

4. The remotely controlled gate system of claim 3, wherein the at least one cable extends horizontally between the first gate arm and the second gate arm when the first gate arm is in the vertical position, wherein the at least one cable lays upon a ground surface when the first gate arm is in a horizontal position.

5. The remotely controlled gate system of claim 1, further comprising a first gate post and a second gate post, wherein the second gate arm is connected to the second gate post.

6. The remotely controlled gate system of claim 5, wherein the frame is connected to the first gate post.

7. The remotely controlled gate system of claim 5, further comprising a gate arm receiver connected to the second gate post.

8. The remotely controlled gate system of claim 7, wherein the second gate arm is removably connected to the gate arm receiver.

9. The remotely controlled gate system of claim 1, wherein extension of the actuator is operable to pivotally lower the first gate arm into the horizontal position.

10. The remotely controlled gate system of claim 9, wherein retraction of the actuator is operable to pivotally raise the first gate arm into the vertical position.

11. A remotely controlled gate system, comprising:
a frame comprising an upper end and a lower end;
a locking member connected to an upper end of the frame;
a first gate arm pivotally connected to the frame, wherein the first locking member is adjustable between a lock position for removably securing the first gate arm in a vertical position and a release position for releasing the first gate arm;
an actuator connected between the frame and the first gate post, wherein the actuator is adapted to pivotally adjust the first gate arm between a horizontal position and a vertical position, wherein the actuator is adapted to adjust the locking member between the lock position and the release position; and
a second gate arm connected to the first gate arm by at least cable.

12. The remotely controlled gate system of claim 11, wherein extension of the actuator is operable to pivot the locking member into the release position and wherein retraction of the actuator is operable to pivot the locking member into the lock position.

13. The remotely controlled gate system of claim 11, wherein an upper end of the first gate arm includes a fin for releasably engaging with the locking member.

14. The remotely controlled gate system of claim 13, wherein the locking member includes a notch, wherein the fin is releasably engaged with the notch.

15. The remotely controlled gate system of claim 11, wherein the actuator comprises a base and a shaft movably extending from the base, wherein the base of the actuator is connected to the frame and wherein the shaft of the actuator is connected to the first gate arm.

16. The remotely controlled gate system of claim 15, further comprising a pivot connector pivotally connected to the frame, wherein the base of the actuator is connected to the pivot connector, wherein the actuator is operable to pivot the pivot connector with respect to the frame.

17. The remotely controlled gate system of claim 16, further comprising a linkage rod connected between the pivot connector and the locking member.

18. The remotely controlled gate system of claim 17, wherein pivoting of the pivot connector in a first direction raises the linkage rod and the locking member, wherein pivoting of the pivot connector in a second direction lowers the linkage rod and the locking member.

19. A remotely controlled gate system, comprising:
a frame comprising an upper end and a lower end;
a first gate arm pivotally connected to the frame;
an actuator connected between the frame and the first gate post, wherein the actuator is adapted to pivotally adjust the first gate arm between a horizontal position and a vertical position;
a control unit for operating the actuator, wherein the control unit is connected to an antenna;
a controller in remote communication with the control unit; and
a second gate arm connected to the first gate arm by at least one cross member.

20. The remotely controlled gate system of claim 19, wherein the control unit includes a battery, further comprising a solar panel connected to the frame for charging the battery.
